(19) United States
(12) Patent Application Publication
(10) Pub. No.: US 2004/0064387 A1
(43) Pub. Date: Apr. 1, 2004

(54) Customized event messaging in an electronic bill presentment and payment system

(76) Inventors: William D. Clarke, Florence, MA (US); Robert A. Laprade, Hadley, MA (US); Daniel M. Palma, Wilbraham, MA (US); Anita Rao, Northampton, MA (US)

Correspondence Address: PITNEY BOWES INC., 35 WATERVIEW DRIVE, P.O. BOX 3000, MSC 26-22, SHELTON, CT, 06484-8000, US

(21) Appl. No.: 10/260,385

(22) Filed: Sep. 30, 2002

(51) Int. Cl. G06F 17/60

(52) U.S. Cl. 705/34

(57) ABSTRACT

A customizable electronic bill payment and presentment system whereby the base logic for event notification messaging need not be changed in order to provide customization to different billers. Rather, customization features are stored in data repositories, preferably in XML format. An administrator can select which events will trigger event notification messages, control parameters for processing the event messages, and who will receive messages. Also, customizable message templates are provided in the data repositories. These templates can provide messages in different languages based the recipient. Also, the templates may provide different customizable messages to different recipients depending on the role of the recipient. Accordingly, customization for a particular biller is achieved by changing data stored in a repository, rather than reprogramming core logic.

### TECHNICAL FIELD

The present invention relates to event messaging in a customizable electronic bill presentment and payment (EBPP) system.

### BACKGROUND

Many organizations are becoming more involved in conducting business electronically (so called e-business), over the Internet, or on other computer networks. E-business calls for specialized applications software such as Electronic Bill Presentment and Payment (EBPP) and Electronic Statement Presentment applications. To implement such applications, traditional paper documents have to be converted to electronic form to be processed electronically and exchanged over the Internet, or otherwise, with customers, suppliers, or others. The paper documents will typically be re-formatted to be presented electronically using Hypertext Markup Language (HTML) Web pages, e-mail messages, Extensible Markup Language (XML) messages, or other electronic formats suitable for electronic exchange, processing, display and/or printing.

Billers who provide their customers with the option of viewing and paying their bills over the Internet have varying requirements for business content to present. In addition to varying content, different billers will want the customer interface and presentation of the billing information to have a particular “look-and-feel.”

Instead of programming their own EBPP system from scratch, billers have the option of purchasing or outsourcing a pre-made EBPP system from a vendor. The biller may also hire a third party electronic billing service to provide the desired EBPP services to the billers customers. In any of these situations, a pre-made EBPP system must be customized to meet the particular business and presentation requirements of the biller. Accordingly, a vendor who provides an EBPP solution to multiple billers needs to consider the extent to which its system can be customized, and the ease with which customization can be achieved.

FIG. 1 depicts a prior art EBPP system. In the prior art system, for one or more billers, EBPP computer system 10 controls the presentment of billing service web pages 40 over the Internet 2 to customer 1. Billing information is gathered by EBPP computer system 10 from the biller's legacy computer systems 20. Typically, billing data will be parsed by EBPP system 10 from a print stream generated by the legacy system 20, the legacy print stream being originally intended for printing conventional hard-copy bills. A preferred method for parsing billing data from the legacy print stream is described in co-pending patent application Ser. No. 09/502,314, titled Data Parsing System for Use in Electronic Commerce, filed Feb. 11, 2000, which is hereby incorporated by reference into this application.

In addition to communication via web pages 40 generated during a session, EBPP computer system 10 includes the capability of sending and receiving e-mail messages 50 to and from the user 1. In one type of e-mail communication, the user 1 may transmit a message to the EBPP computer system 10. Such a communication, for example, might be in regard to a request for technical support, or to notify the biller of a change in the user's account information. The email system of the EBPP system 10 will forward the message to the appropriate recipient, and a dialogue is begun.

In another type of e-mail communication, as shown in FIG. 2, system 10 will automatically generate a message to user 1 upon the occurrence of a predetermined event. An example of such an event is a new billing statement becoming available, or the approach of a due date for an unpaid bill. A system monitoring agent acting as part of the back end services logic 14 detects the occurrence of an event and activates event processor 15. The event processor 15 generates the body of an appropriate e-mail message by making HTTP calls to Java Server Pages (JSP's) 17 in front end presentation logic 14. A publisher notification URL table 16 lists appropriate URL addresses for the respective JSP's for different events. These URL addresses are retrieved by event processor 15. The JSP's 17 include code describing content and format of e-mail notification messages for the particular biller. These JSP's can be recoded for customizing the system to suit the particular business needs of a particular biller. Such JSP code modification can be achieved using Macromedia's Dreamweaver, or other Web site development software.

When the event processor 15 makes the HTTP call to the appropriate JSP 17, a formatted customized text or HTML page is returned. The returned page is used as the body of the message. The event processor 15 puts the completed message into the e-mail message table 18 to be sent by the SMTP e-mail server 19. Upon completion of these tasks, the event processor agent 15 marks the event as processed.

Returning to FIG. 1, EBPP system 10 is also capable of communicating with a bank or ACH network 30 to process bill payment activities.

System 10 includes a data repository 11 in which billing data for use with system 10 may be stored in a variety of formats. Data in the repository can be organized in a database, such as the kind available from Oracle or DB2. Statement data archives may also be stored in a compressed XML format. XML is a format that allows users to define data tags for the information being stored.

The EBPP computer system 10 itself is typically comprised of standard computer hardware capable of processing and storing high volumes of data, preferably utilizing a J2EE platform. EBPP system 10 is also capable of Internet and network communications. The prior art EBPP computer system 10 includes a software architecture within an application server 12 for generating and handling electronic billing functions. At a fundamental level, the software architecture of the prior art system 10 is split into two conceptual components, the front-end presentation logic 13 and the back end servicing logic 14. The split between front-end and back-end logic 13 and 14 serves to reduce the amount of recoding necessary for the system to be customized for different billers.

The front-end presentation logic 13 is the portion of the software that is the primary Internet interface for generating web page presentations. As such, the front end presentation logic 13 includes code that is custom written to meet the specific business and presentation needs of the biller. Functionality that might be included in front-end logic 13 is enrollment, presentation, payment instructions, and reporting.

Typically, front-end logic 13 is comprised of Java Server Pages (JSP's) that control the presentation of billing information in the form of web pages. The front-end logic JSP's also receive and respond to inputs as the customer makes requests for various services to be provided. The JSP's can be recoded to accommodate different look-and-feel and business requirements of different billers. Within the JSP'S, front-end logic 13 can also utilize Enterprise Java Beans (EJB's) that comprise objects for performing specific tasks.

The back-end services logic 14 comprises the software for functions that typically do not need to be customized for particular billers. Preferably, very little of the back-end services must be customized for a particular billers needs. For example, back-end logic may include the software for extracting the billing data from the biller legacy billing computers 20. Similarly, logic for handling of payments with the bank or ACH network 30 and systems for generating and receiving e-mail messages will be handled in the back-end services logic 14.

As a result of the distinction between the front-end and back-end logic 13 and 14, re-coding of software to provide customization for different billers is somewhat reduced. However, a significant amount of presentation logic and some business logic must always be re-written to meet a particular biller's needs. The re-coding required for customization can require a high degree of programming skill and can add expense to implementation of a billers on-line presence. The requirement for re-writing code introduces a risk that changes to the way that a web page looks may in fact introduce a problem that could cause the content of the information being displayed to be incorrect. Another problem with this prior art system is that after a system is customized it may be difficult to provide upgrades and future releases of the software. In order to be sure that new releases work properly substantial efforts would be necessary to retrofit the new release with the code changes that were made for the particular biller.

In the prior art EBPP system 10, back end logic 14 or front end logic 13 may also include software agents that perform periodic tasks without prompting from an end-user 1. For example, the system 10 may monitor for events such as the presence of new billing information available to be loaded. Upon detecting the presence of new billing information, a software agent runs a job to load the new information based on parameters programmed into the software agent. The software agent may also invoke a notification message to be sent, as described above.

As with other aspects of the front and back end logic 13 and 14, the ability to customize the notification messages is an important consideration in enabling a system used to service multiple billers. If a biller wanted notification messages based on different parameters, or with different text, than another biller, then those varying parameters may require recoding or reprogramming of logic. Similarly, a biller may only want to provide notification messages for some events, but not others, in providing EBPP services. Event messages that are important to one biller, may be of little interest to another. Thus the concerns about customization and upgradeability discussed above, need to be considered for the event notification messaging portions of the EBPP systems.

Accordingly, the prior art leaves disadvantages and needs to be addressed by the present invention, as discussed below.

### SUMMARY OF THE INVENTION

The present invention provides a customizable EBPP system whereby the base logic for providing notification messages to customers and to system administrators need not be changed in order to provide customized event notification messages to suit different billers. Rather, customization features are stored in data repositories, preferably in XML format. An administrator can select which events will trigger event notification messages, and who will receive messages. Customizable message templates are stored in the data repositories. These templates can provide messages in different languages based on language preferences indicated by a recipient. Also, the templates provide different customizable messages to different recipients depending on the role of the recipient. For example, for the same event, an administrator may receive a different message than a customer. Accordingly, customization for a particular biller is achieved by changing data stored in an easily modified repository, rather than reprogramming core logic.

The electronic bill presentment computer system of the present invention provides bill information from a biller to a remote customer over a network. During operation of the system, there are various events that occur for which it is advantageous to provide event notification messages to interested parties. For example, an e-mail message may be sent to a customer to inform him or her that an on-line bill is ready for review. Similarly, an email notification may be sent to a system administrator informing the administrator of an error or a change of status in the EBPP system. The present invention allows that the event notification messages can be customized to meet preferences of the biller for whom the EBPP system is providing services.

To facilitate customization, the EBPP system includes an event messaging descriptor repository storing customized information in accordance with biller preferences. An business logic module invokes notification messaging based on occurrences of predetermined events, such as the availability of new bills, or the occurrence of system errors. Responsive to the occurrence of an event, an event messaging logic module generates customized event messages based on corresponding information stored in the event messaging descriptor repository. The event messaging logic module is preferably comprised of standardized logic components operating in accordance with the customized descriptors, and automatically creates customized software implementations. As such, it is preferred that the event messaging descriptor repository be discrete from the event messaging logic module, thereby providing that the repository independently reflects the biller's particular preferences, and that the information in said repository being customizable for the biller. The standardized logic may create sub-groups of software object classes tailored to the customized descriptors. After the message has been generated, a message delivery means transmits the customized event messages to one or more recipients.

In the preferred embodiment, the event messaging descriptor repository is stored using descriptors in XML format. Also, the descriptor repository preferably includes a plurality of message templates corresponding to different events handled by the messaging system.

The repository may also preferably include alternate message templates in different languages. The appropriate language template may be selected based on the preferences or geographic location of the intended recipient.

Templates in the descriptor repository may also include a first text message for a first recipient and a second text message for a second recipient. When an event occurs, the message delivery means then delivers the first message to the first recipient and the second message to the second recipient. Thus, appropriate messages may be sent to recipients having different roles, such as customer or system administrator.

The event messaging descriptor repository also preferably includes higher level descriptors providing a customizable listing of events for which event messages will be produced. The descriptor repository may also include customized parameters for each of the selected events. The customized event parameters may be used to control the event messaging processing for each of the events selected for messaging by the particular biller.

Other variations on the basic invention will be described in the detailed description and the enumerated claims below.

### BRIEF DESCRIPTION OF DRAWINGS

The present invention is illustrated by way of example, in the figures of the accompanying drawings, wherein elements having the same reference numeral designations represent like elements throughout and wherein:

FIG. 1 is a prior art EBPP system;

FIG. 2 is a prior art event messaging system in a prior art EBPP system;

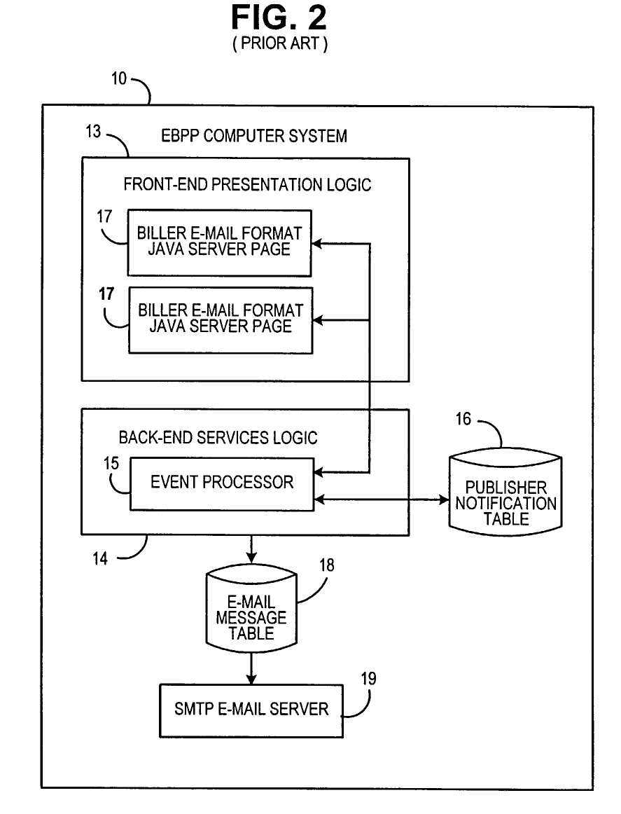

FIG. 3 is a preferred embodiment of a customizable event messaging system for an EBPP system in accordance with the present invention;

FIG. 4 is a further preferred embodiment of a customizable event messaging system for an EBPP system in accordance with the present invention.

### DETAILED DESCRIPTION OF THE INVENTION

Reference is made to a previously filed U.S. patent application Ser. No. 10/153,105, entitled CUSTOMIZABLE ELECTRONIC BILL PRESENTMENT PAYMENT SYSTEM AND METHOD, by Robert Laprade, et al., filed May 22, 2002, (Docket F-499), to application Ser. No. 10/184,159 entitled CUSTOMIZABLE SOFTWARE AGENTS IN AN ELECTRONIC BILL PRESENTMENT AND PAYMENT SYSTEM, and to application Ser. No. 10/185,924 entitled TEMPLATE FOR INPUTTING CUSTOMIZED PROCESSING FEATURES IN AN ELECTRONIC BILL PRESENTMENT AND PAYMENT SYSTEM, both by Andrew Tosswill and filed Jun. 28, 2002 (Dockets F-503, F-504). These referenced patent applications are hereby incorporated by reference.

A customizable EBPP system for use with the present invention is described in co-pending patent application Ser. No. 10/153,105, entitled CUSTOMIZABLE ELECTRONIC BILL PRESENTMENT PAYMENT SYSTEM AND METHOD, by Robert Laprade, et al., filed May 22, 2002. The description provided herein provides a further enhancement providing customizable event messaging that may be used with such an EBPP system.

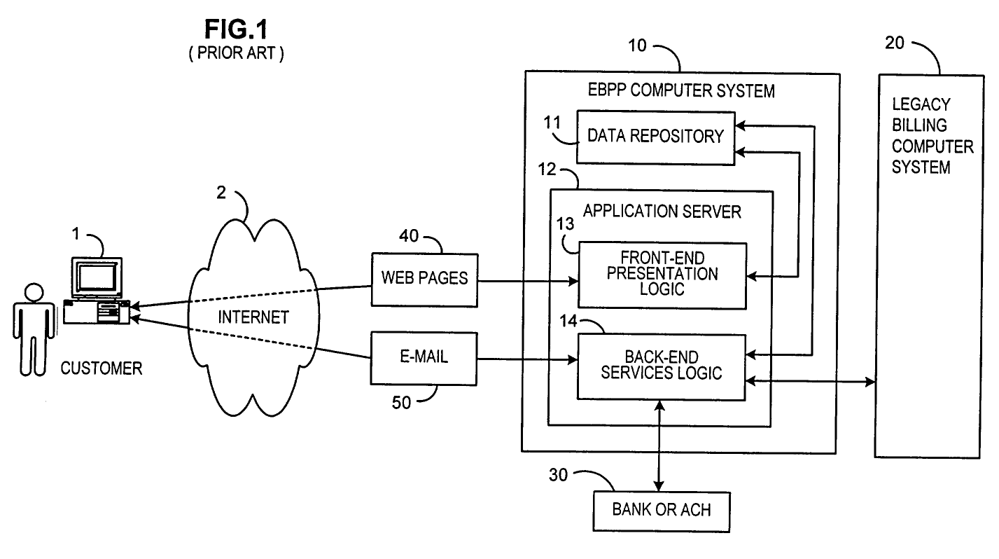

As seen in FIG. 1, the logic for handling the business aspects of EBPP system 100 in accordance with the present invention is represented as event business logic 320. Business logic 320 is comprised of business objects 321 handling separate business functions of the system. Preferably, each of the business objects 321 include a method for invoking the appropriate event messaging logic 340 when an event occurs. Thus, for example, if the business object handles loading of new customer statements, one of a checklist of things to do is to invoke messaging logic 340 to determine what notification messages are necessary, if any, and to generate and send an appropriate message. The base code of the event business logic 320 includes a call to the event factory logic 341 (see below) to initiate appropriate event messaging logic 340. Event messaging logic 340 determines whether the detected event is one for which the biller has selected event notification messaging capability. If the event requires a notification message, event messaging logic 340 determines the biller selected parameters for processing the message. Finally, the event messaging logic composes the message, customized to the biller's requirements, to be sent to the appropriate recipients selected by the biller.

Event messaging logic 340 is comprised of base code that is common to other billers that use the EBPP system of the present invention. Therefore, to determine the event messaging features activated for the particular biller, event messaging logic 340 operates in accordance with scripts of customized instructions included in the separate event messaging descriptor repository 350. Descriptors in repository 350 are preferably written in XML format, as will be shown in examples below. To compose a message in accordance with the event messaging descriptors in repository 350, event messaging logic 340 also accesses appropriate data from the business data repository 140. Business data repository 140 includes the customer and billing data around which the EBPP system is built.

Once the event message has been composed in accordance with the descriptors in descriptor repository 350 and data from data repository 140, the finished message is sent to a message content repository 360 where it is stored until it is transmitted to its intended recipient by the SMTP e-mail server 370. Exemplary recipients may be a customer 1 or system administrator 3, or both. As an alternative to sending the finished message by e-mail, the message may be posted via HTML on a web page on a network such as the Internet. To allow the option of more than one way of conveying the message (such as e-mail or web page) event messaging logic 340 creates the text of the message in multiple formats for storage in the message content repository 360.

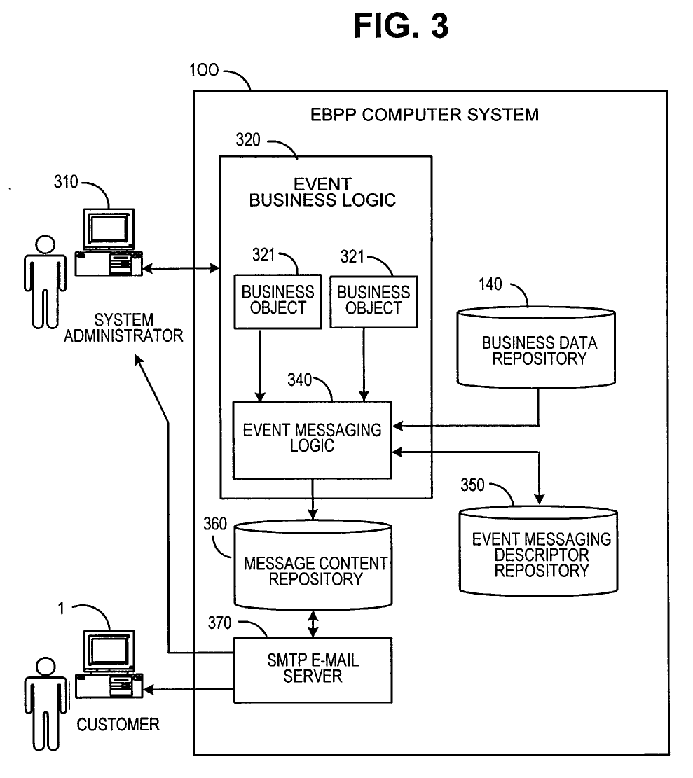

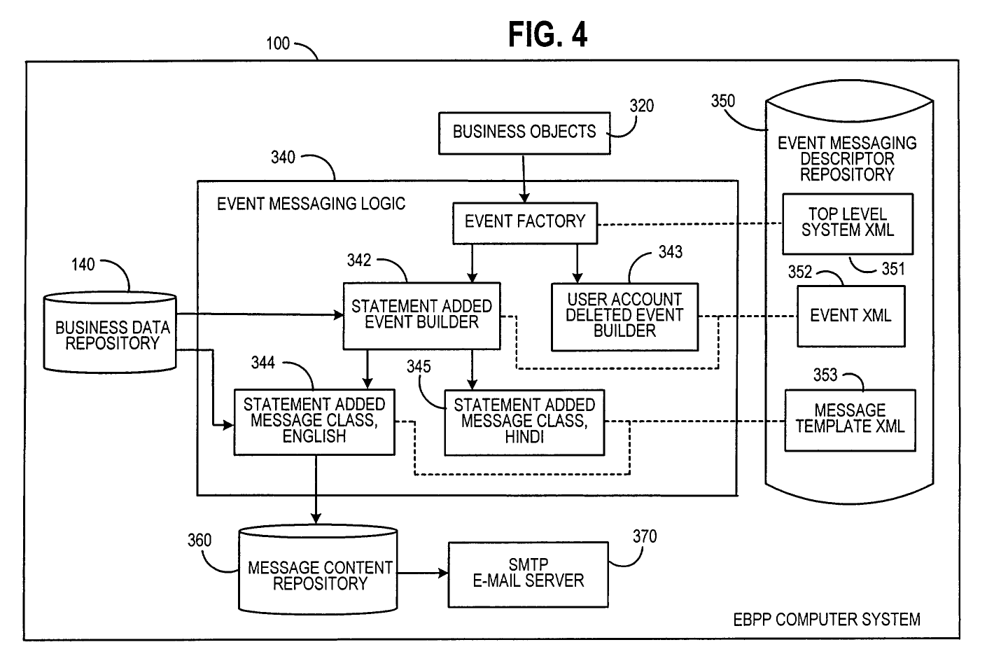

In FIG. 4, a more detailed implementation of the system in FIG. 3 is provided. FIG. 4 depicts various exemplary classes of generated software objects within event messaging logic 340 for carrying out the customized event messaging functionality. In the preferred embodiment, and examples provided below, these software objects are in Java programming language, although any comparable programming language will suffice. These classes are derived from the base code of the event messaging logic 340 in accordance with the customizable descriptors contained in the event messaging descriptor repository 350.

As discussed above, the base code of event business objects 320 includes calls to event messaging logic 340 and more particularly to event factory 341, for use upon the detection of an event. In an exemplary embodiment, a “getEventFactory( )” method is located in the base class for all business objects 321. An messaging event for a statement added event can be triggered in a business object 321 as follows:

try

{

EventFactory eventFactory = getEventFactory(factory,userContextData);
EmployeeAddedEventBuilder ce = eventFactory.getEmployeeAddedEventBuilder( );
ce.triggerEvent(EmployeeId( ));

}
catch(RequiredEventDataNotPresentException e)
{

throw new InternalErrorException( );

}
catch(CreateEventException e)
{

throw new InternalErrorException( );

}
catch(Exception e)
{

CaughtException(e);
ejbCtx.setRollbackOnly( );
throw e;

}

Exemplary notification events may include: a statement being added to the customer's account; user information being deleted from the system; the document collector for gathering business data from the billers legacy computers failing; a user's enrollment attempt being rejected; the system e-mail processor failing; a customer account being added; a customer account being updated; a customer enrolling; and various events relating to system job execution status.

Events in the EBPP system 100 may be classified into three general types. These types may affect the content and recipients of the messages. An “account” type of event relates to customer account related activity. Examples of “account” events may be StatementAdded or UserAccountUpdated events. A “user” event relate relevant to a particular user, or users, but not necessarily to any account. For example, UserInfoUpdated and UserPaymentProfileAdded are “user” events. A third kind of event are “system” events related to functioning of the EBPP system, not to any particular user or account. “System” events typically only generate messages for system administrators, while the other two types of events may result in messages directed to both customers and system administrators.

The event factory object 341, is generated from top level XML descriptors called the top level system XML 351 in the event messaging descriptor repository 350. The event factory 341 provides a top level interface for accessing the event messaging functionality that has been selected for use with the particular EBPP system.

Exemplary top level system event XML 351 for generating the event factory 341 is as follows:

<D3Events xmlns:xlink = “http://www.w3.org/1999/xlink”>

<Event_link name =”StatementAdded” xlink:type=”simple”

xlink:href=”event_xml/StatementAdded.xml” dbKey=”1” Priority=”2”/>

<Event_link name =”UserAccountDeleted” xlink:type=”simple”

xlink:href=”event_xml/UserAccountDeleted.xml” dbKey=”2” Priority=”1”/>

<Event_link name =”DocumentCollectorFailed” xlink:type=”simple”

xlink:href=”event_xml/DocumentCollectorFailed.xml” dbKey=”3”
Priority=”3”/>

</D3Events>

This exemplary system XML 351 includes events for “StatementAdded,” “UserAccountDeleted” and “DocumentCollectorFailed.”

The following exemplary event factory 341 class and implementation code is generated by the base event messaging logic code 340, from the top level XML 351:

public interface eventFactory
{

public StatementAddedEventBuilder

getStatementAddedEventBuilder(long StatementId, long PublisherId, String
AccountKey);

public UserAccountDeletedEventBuilder

getUserAccountDeletedEventBuilder(String AccountKey, long PublisherId);

public DocumentCollectorFailedEventBuilder getDocumentCollectorFailedEventBuilder( );
public static int STATEMENTADDED =1;
public static int USERACCOUNTDELETED =2;
public static int DOCUMENTCOLLECTORFAILED =3;
public static int STATEMENTADDED_PRIORITY =2;
public static int USERACCOUNTDELETED_PRIORITY =1;
public static int DOCUMENTCOLLECTORFAILED_PRIORITY =3;

}
public class eventFactoryImpl
{

private DataFactory dataFactory = null;
public eventFactoryImpl(DataFactory df)

{

dataFactory = df;

}
public StatementAddedEventBuilder getStatementAddedEventBuilder( )
{

StatementAddedEventBuilder c =null;
try
{

c = new StatementAddedEventBuilderImpl(dataFactory);

}
catch (Exception e)
{

e.printStackTrace( );

}
return c;

}
public UserAccountDeletedEventBuilder getUserAccountDeletedEventBuilder( )
{

.....

}
public DocumentCollectorFailedEventBuilder getDocumentCollectorFailedEventBuilder( )
{

.....

}

}

The EventFactory preferably includes methods to get the java class of an event without naming of the actual class. This provides greater extensibility because even if the name of the class that does the actual work changes, the business objects 321 don't need to be changed to invoke the new class.

In addition to creating Java from the XML specification, sql database instructions may also be generated. Based on top level system XML 351, the following example of sql instructions may be generated:

Truncate table eventtype;

INSERT INTO EVENTTYPE (EventTypeId, Name, SendToInactiveUser, SendToRejectedAccount, SmtpDelivery, Category, Description, Priority) values (1, ‘AgentFailure’, ‘N’, ‘N’, ‘Y’, ‘System’, ‘Agent failed’, 3);

INSERT INTO EVENTTYPE (EventTypeId, Name, SendToInactiveUser, SendToRejectedAccount, SmtpDelivery, Category, Description, Priority) values (6, ‘EmployeeAdded’, ‘N’, ‘N’, ‘Y’, ‘User’, ‘New Employee’, 1);

Commit;

For each of the events recognized by the event factory 341 there is an event builder class that handles the triggering and processing of information to generate an appropriate message. In FIG. 4, exemplary StatementAdded event builder 342 and UserAccountDeleted event builder 343 are depicted. Preferably, there will be an event builder class for every event that is to be processed for notification messaging. Event builders 342 and 343 include methods to record the occurrence of a new event. Event builders 342 and 343 check whether the mandatory fields are present . The event builders also handle the triggering of the message creation upon receiving a method call from the business objects 320. The event builders 342 and 343 are generated based on descriptors in the event XML 352. The event XML 352 includes descriptions of the fields necessary for proper processing of the event builders.

Exemplary event XML 352 descriptors for the StatementAdded event builder 342 might be as follows:

<?xml version=“1.0” encoding=“UTF-8” ?>

<Event Name=“StatementAdded” Type=“Account”
SendToInactiveUser=“false” >
<Description>Statement online for end user viewing</Description>
<EventCreationFields>

<Field name=“StatementId” type=“long” mandatory=“true”/>
<Field name=“PublisherId” type=“long” mandatory=“true”/>
<Field name=“AccountKey” type=“String” mandatory=“true”/>

</EventCreationFields>

</Event>

In this example, “EventCreationFields” are required data for the event. The vent is considered incomplete when any of the mandatory data is absent with the business object 321 triggers the event. During event message creation, each of these fields is to be used. When the Field has the attribute “mandatory=true,” that field is typically a primary key for a table where information is required during message creation. In the example above, StatementId is a primary key of a statement table in the business data repository 140.

This event XML 352 would generate a StatementAddedEventBuilder 342 interface and a class that implements an interface called “StatementAddedEventBuilderlmpl.” The DTD (document type definition) for the above XML 352 is:

<!ELEMENT Event(Description, Priority, EventCreationReqdFields)>

<!ATTLIST Event Name PCDATA #REQUIRED>
<!ATTLIST Event Type (Account|User|System) #REQUIRED>
<!ATTLIST Event SendToInactiveUser (true|false) #REQUIRED>
<!ELEMENT Description (#PCDATA)>

<!ELEMENT EventCreationFields (Field*)>

<!ELEMENT Field (#PCDATA)>

<!ATTLIST Field Name PCDATA #REQUIRED>
<!ATTLIST Field type PCDATA #REQUIRED>
<!ATTLIST Field mandatory (true|false) #REQUIRED>

The resulting interface for the StatementAddedEventBuilder 342 based on the exemplary event XML will be:

public interface StatementAddedEventBuilder
{

public boolean triggerEvent( long StatementId, long PublisherId, String AccountKey )

throws RequiredEventDataNotPresentException, CreateEventException,
CreateEventMessageException,MessageClassNotPresentException;

}

Preferably, the implementation class for the StatementAddedEventBuilder 342 will include three methods, described as follows:

TriggerEvent( )

This method is used to trigger the new event. This method is called from the business objects 320, to process an event. It invokes the CreateEvent( ) and CreateEventMessage( ) methods (see below).

CreateEvent( )

This method is used to record new event details. It also checks whether the mandatory fields are present (as defined in the event XML 352). It is invoked by the triggerEvent( ) method.

CreateEventMessage( )

This protected method calls appropriate message class for this event and constructs the message. It also sends the message to the subscribed users. It is invoked by the triggerEvent( ) method.

A skeletal example for the implementation of the StatementAdded EventBuilder 342 is provided at the end of this specification under the heading “StatementAdded event builder implementation.”

In forming the event messages, the event builders 342 and 343 call upon respective message classes that include the text content and variables for forming the message. The message classes for the StatementAdded event builder 342 are StatementAdded message class (English) 344 and StatementAdded message class (Hindi) 345. These message classes are formed in accordance with message template XML 353 in the event messaging descriptor repository 350. The message template XML 353 includes text to be included in the body of the message. Template XML 353 also identifies variables such as the addressee's name that will be filled in with reference to the business data repository 140.

Template XML 353 may also include different sets of body text for the same event. The different sets of body text are delivered to recipients having different roles. For example, a first set of text to be addressed to the customer may indicate that a new statement is available for his or her review. For the same event, a system administrator may receive a notification that the new statement is available for the customer, and that the administrator should verify the correctness of the statement.

Template XML 353 may also include templates for the same event in different languages. A separate message class will be created for each of the languages. The event builder class will invoke the appropriate language message class by checking a language preference of the customer from the business data repository 140, or by selecting a default language based on the location of the customer, as indicated by the business data repository 140. Thus a customer in the U.S. may receive a message generated from the English message class 344, and a customer in India may receive a message generated from a Hindi message class 345.

An exemplary message template for a message template XML 353 in English for a StatementAdded event may be as follows: A detailed example for the a message template XML 353 in English for a StatementAdded event is provided at the end of this specification under the heading “StatementAdded message template XML.”

The DTD for the exemplary message template XML is:

<!ELEMENT Message (AddressedTo*)>

<!ATTLIST Message Name PCDATA #REQUIRED>

<!ELEMENT AddressedTo ( TextContent?, HtmlContent?)

<!ATTLIST AddressedTo Group PCDATA #REQUIRED>

<!ELEMENT HtmlContent (Subject, EmailBody, Attachment*)>
<!ELEMENT TextContent (Subject, EmailBody, Attachment*)>

<!ELEMENT Subject #PCDATA >
<!ELEMENT EmailBody #CDATA >
<!ELEMENT Attachment #CDATA >

It should be noted that the “addressedTo” attribute in the message template example given indicates the user group the message is addressed to. The “default” setting shown in the example may indicate that the message is to be sent to one or more groups of potential recipients, based on the type of message.

As can be seen from the exemplary message template XML 353 provided, the template may include text for more than one recipient. In this example, the “Admin” group and the “Default” group will receive different messages with different text reflecting their different roles.

In an alternative embodiment, the message template XML may also include references to logic for formatting the variables to be inserted into the message. For example a quantity for date or currency may be known, but the format may be dependent on geographic location or user preferences. A date variable may be inserted into the message template XML 353 in the format “<%=formatDate(Statement.getStatementDate( ), ” MM\dd\yyy)%>.“Thus, using this exemplary template, the date will be displayed in MM\dd\yyyy format. Preferably, all date formats supported by Java are supported in the message template XML 353.

In another alternative embodiment, a biller may wish to include a common body of text in all messages. For example, a signature giving the name and contact information for an administrator may be included at the end of all e-mail messages. Instead of writing the text in every template, a path for a signature file can be indicated. For example, the message template XML 353 can be modified to include “<%@include FilePath %>.” The FilePath can be an absolute file path or a path relative to an XML directory. The XML tag “@include” reads the file and appends the data from the file into the message. Every time the “include” file changes, preferably, the message classes 344 and/or 345 are recompiled.

From the message template XML 353 message classes 344 and 345, and others, are created. A message class is created from message template 353 for each notification event in the EBPP system. All message classes implement a message template interface. The corresponding eventBuilder class calls this message class. An example of an implementation for message class 344 is provided at the end of this specification after the heading “Message Class Message Template Interface.”

Where there are messages in multiple languages for a single event a naming convention for naming of the message classes is preferably applied. A preferred naming convention for the message class is EventName}_{locale{_{Country}. Thus a message class would be called “StatementAdded_en_US” for English messages in United States, or “StatementAdded_hi_IN” for Hindi messages in India.

The message classes according to the present invention resolve all the variables in the message template and returns the message as a digital document or as a string, having both text and html messages. In the exemplary message class provided, the variables in the message body include those named as {<TableName>.get<FieldName>( )}. For e.g.: {Publisher.getName( )}.

The exemplary StatementAdded message class 344 is called from the createEventMessage( ) method in the StatementAdded EventBuilder 342. For events that are biller specific, billers can customize their message templates. A billers customized message template for an event is preferably given preference over default event message templates that may be provided with the EBPP system. If a biller wants to override the contents of a default message, the default message may be copied and edited as desired.

Once a message has been formed from the message classes, such as 344 and 345, the completed message is stored in a message content repository 360. Preferably the message is stored as a digital document in a database. The documents are also preferably stored as both text and as HTML, so that the message can be provided in the format preferred by the recipient. From the message content repository 360 a message transmittal device such as an SMTP e-mail server 370 can immediately send the notification messages to the intended recipients.

While the present invention is described in connection with what is presently considered to be the preferred embodiments, it is to be understood that the invention is not limited to the disclosed embodiment, but is intended to cover various modifications and equivalent arrangements included within the spirit and scope of the appended claims. It should also be understood that certain features of the system described herein may be considered novel inventions in their own right, even if separated from the overall system described herein, and that the scope of protection afforded to the patentee should be determined in view of the appended claims.

StatementAdded Event Builder Implementation

public class StatementAddedEventBuilderImpl extends EventBase implements
StatementAddedEventBuilder
{
protected static final Category CAT = Category.getInstance(StatementAddedEventBuilderImpl.class);

public StatementAddedEventBuilderImpl(DataFactory df, UserContextData uc)
{

dataFactory = df;
UserContextData = uc;
type = “ACCOUNT”;
eventTypeId = EventFactory.STATEMENTADDED;
eventName = “StatementAdded”;
Priority = EventFactory.STATEMENTADDED_PRIORITY;
// Configure the log4j logging Category
SendToInactiveUser = false;
if (CAT.getHierarchy( ).getRoot( ).getAllAppenders( ) instanceof NullEnumeration)

BasicConfigurator.configure( );

}
public boolean triggerEvent( long StatementId, long PublisherId, String AccountKey )

throws RequiredEventDataNotPresentException, CreateEventException,
CreateEventMessageException, MessageClassNotPresentException

{

final String thisMethodsSignature = “triggerEvent( )”;
CAT.debug(LogUtil.METHOD_BEGIN+thisMethodsSignature);
boolean failed = false;
try
{

createEvent( StatementId,PublisherId,AccountKey );

}
catch(RequiredEventDataNotPresentException e)
{

failed = true;
throw e;

}
catch(CreateEventException e)
{

failed = true;
throw e;

}
finally
{

if (failed) updateEvent(“failed”);

}
try
{

createEventMessage( StatementId,PublisherId,AccountKey );

}
catch(CreateEventMessageException e)
{

failed = true;
throw e;

}
catch(MessageClassNotPresentException e)
{

failed = true;
throw e;

}
finally
{

if (failed) updateEvent(“failed”);

}
updateEvent(“processed”);
CAT.debug(LogUtil.METHOD_END+thisMethodsSignature);
return true;

}
protected boolean createEvent( long StatementId, long PublisherId, String AccountKey )

throws RequiredEventDataNotPresentException, CreateEventException

{

final String thisMethodsSignature = “createEvent( )”;
CAT.debug(LogUtil.METHOD_BEGlN+thisMethodsSignature);

if (StatementId==0) throw new RequiredEventDataNotPresentException( );
if (PublisherId==0) throw new RequiredEventDataNotPresentException( );
if (AccountKey==null) throw new RequiredEventDataNotPresentException( );
DataSourceConnection connection = null;

try
{

Event = dataFactory.newEvent( );
connection = dataFactory.allocateConnection ( );
Event.setEventTypeId(EventFactory.STATEMENTADDED);
Event.setStatementId(StatementId);
Event.setPublisherId(PublisherId);
Event.setAccountKey(AccountKey);
Event.setTimeQueued(new java.util.Date( ));
EventMapper eqMapper = dataFactory.getEventMapper(connection,
getMultiTenantBoolean (UserContextData) );
eqMapper.insert(Event);

}
catch(Exception e)
{

throw new CreateEventException( );

}
finally
{

try
{

if (connection != null) dataFactory.releaseConnection (connection);

}

| catch (DataException e) | |
|---|---|
| { | e.printStackTrace( ); |

throw new CreateEventException( );

}

}
CAT.debug(LogUtil.METHOD_END+thisMethodsSignature);
return true;

}
protected boolean createEventMessage( long StatementId, long PublisherId, String AccountKey )

throws CreateEventMessageException, MessageClassNotPresentException

{

final String thisMethodsSignature = “createEventMessage( )”;
CAT.debug(LogUtil.METHOD_BEGIN+thisMethodsSignature);

createEventMessagesForUsers( );
CAT.debug(LogUtil.METHOD_END+thisMethodsSignature);
return true;

}

}

StatementAdded Message Template XML

<?xml version=“1.0” encoding =“UTF-8”?>
<Message name=“StatementAdded”>
<AddressedTo group=“Default”>
<HtmlContent>

<Subject>Notice of Statement Delivery</Subject>
<EmailBody>

```
<![CDATA[
<html><body>
<font face=“Arial”>
<p>{TargetUserInfo.getFirstName( )},</p>
<p>
You have received a Statement for the most recent billing period.
<br>
Make certain this information is correct and submit payment by
Statement.getDueDate( )}
<br>
If you find any discrepancies, you can contact Customer Service at:</p>
<table cellpadding=“0” cellspacing=“0” border=“0”>
  <tr>
    <td align=“left”>Telephone:&nbsp;</td>
    <td align=“left”>{Publisher.getCustomerServicePhoneNumber( )}</td>
  </tr>
</table>
<p>Thank You,</p>
<p><b>{Publisher.getCustomerServiceName( )}</b><br>
{Publisher.getName( )}</p>
</font>
</body></html>
]]>
```

</EmailBody>

</HtmlContent>
<TextContent>

<Subject>Notice of Statement Delivery</Subject>
<EmailBody>

{TargetUserInfo.getFirstName( )}
You have received a Statement for the most recent billing period. Make certain
this information is correct and submit payment by {Statement.getDueDate( )}.
If you find any discrepancies, you can contact Customer Service at:
Telephone: {Publisher.getCustomerServicePhoneNumber( )}
Thank You,
{Publisher.getCustomerServiceName( )}

{Publisher.getName( )}

</EmailBody>

</TextContent>
</AddressedTo>
<AddressedTo group=“Admin”>
<TextContent>

<Subject>Notice of Statement Delivery</Subject>
<EmailBody>

Dear {TargetUserInfo.getFirstName( )},
Please note that {Statement.getName( )} with account number
{Statement.getAccountKey( )} has received a Statement for the most recent billing
period. Please make certain this information is correct.
Thank You,
Service Provider

</EmailBody>

</TextContent>
</AddressedTo>
</Message>

Message Class Message Template Interface

public interface MessageTemplate_Interface
{

public String getEncoding( ) throws Exception;
public long getMessageDigitalDocument( ) throws Exception;
public String getMessageContent( ) throws Exception;
public String getSubject(String type) throws Exception;

}
package com.docsense.app.event.message;
import com.docsense.app.data.*;
import org.apache.log4j.BasicConfigurator;
import org.apache.log4j.Category;
import org.apache.log4j.helpers.NullEnumeration;
import com.docsense.core.LogUtil;
import com.docsense.core.exceptions.data.DataException;
import com.docsense.core.data.*;
import com.docsense.app.event.MessageBase;
import com.docsense.app.event.MessageTemplate_Interface;
public class StatementAdded_en_US extends MessageBase implements
MessageTemplate_Interface
{
protected static final Category CAT = Category.getInstance(StatementAdded_en_US.class);
public StatementAdded_en_US(DataFactory df, UserContextData uc, Event eq, UserInfo tup)
{

dataFactory = df;
Event = eq;
TargetUserInfo = tup;
encoding = “UTF-8”;
UserContextData = uc;
if (CAT.getHierarchy( ).getRoot( ).getAllAppenders( ) instanceof NullEnumeration)

BasicConfigurator.configure( );

}
/* This method returns the encoding the message is in - The encoding is found in the
message.xml.

Errors should be handled by the calling program*/

public String getEncoding( ) throws Exception
{

final String thisMethodsSignature = “getEncoding( )”;
CAT.debug(LogUtil.METHOD_BEGIN+thisMethodsSignature);
CAT.debug(LogUtil.METHOD_END+thisMethodsSignature);
return encoding;

}
/* This method returns message to the calling program. It calls getMessage which resolves the
variables

Errors should be handled by the calling program*/

public String getMessageContent( ) throws Exception
{

final String thisMethodsSignature = “getMessageContent( )”;
CAT.debug(LogUtil.METHOD_BEGIN+thisMethodsSignature);
try
{

getMessage( );

CAT.debug(LogUtil.METHOD_END+thisMethodsSignature);

return Message.toString( );

}
catch(Exception e)
{
CAT.error(“Exception is ”+e.toString( ));

throw e;

}

}
/* This method creates a digital document from the message and saves it to the D3 database

Errors should be handled by the calling program*/

public long getMessageDigitalDocument( ) throws Exception
{

final String thisMethodsSignature = “getMessageDigitalDocument( )”;
CAT.debug(LogUtil.METHOD_BEGIN+thisMethodsSignature);

getMessage( );

CAT.debug(LogUtil.METHOD_END+thisMethodsSignature);

return createDigitalDocument( );

}
/* This method gets the message from the message.xml and composes the message

The variables are resolved. Errors should be handled by the calling program*/

private void getMessage( ) throws Exception
{

final String thisMethodsSignature = “getMessage( )”;
CAT.debug(LogUtil.METHOD_BEGIN+thisMethodsSignature);
StringBuffer msg = new StringBuffer(1915);
resolveVariables( );
if (TargetUserInfo.getGroupName( ).equalsIgnoreCase(“Admin”))
{

msg.append(“<D3EmailMessage>\n”);
msg.append(“<TextContent>\n”);
msg.append(“<Subject>”);
msg.append(“Notice of Statement Delivery”);
msg.append(“</Subject>\n”);
msg.append(“Dear ”+ getPrintableValue(TargetUserInfo.getFirstName( )

)+“,”+“\n”+
“”+“\n”+

| | |
|---|---|
| “ | Please note that ”+ getPrintableValue(Statement.getName( ) )+“ with account |

number ”+ getPrintableValue(Statement.getAccountKey( ) )+“ has received a Statement for the
most recent billing period. “+”\n”+

| “ | Please make certain this information is correct.“+”\n”+ |
|---|---|
| “ | Thank You,“+”\n”+ |
| “ | Service Provider”); |
| | msg.append(“</TextContent>\n”); |
| | msg.append(“<HtmlContent>\n”); |
| | msg.append(“<Subject>\n”); |
| | msg.append(“”); |
| | msg.append(“</Subject>\n<![CDATA[”); |
| | msg.append(“”); |
| | msg.append(“]]> </HtmlContent>\n”); |
| | msg.append(“</D3EmailMessage>\n”); |

}
else
{

msg.append(“<D3EmailMessage>\n”);
msg.append(“<TextContent>\n”);
msg.append(“<Subject>”);
msg.append(“Notice of Statement Delivery”);
msg.append(“</Subject>\n”);
msg.append(“”+ getPrintableValue(TargetUserInfo.getFirstName( ) )+“”+“\n”+

| | |
|---|---|
| “ | ”+“\n”+ |

| | |
|---|---|
| “ | You have received a Statement for the most recent billing period.”+“\n”+ |
| “ | Make certain this information is correct and submit payment by ”+ |

getPrintableValue(Statement.getDueDate( ) )+“.”+“\n”+

| | |
|---|---|
| “ | If you find any discrepancies, you can contact Customer Service at:Telephone:”+ |

getprintableValue(Publisher.getCustomerServicePhoneNumber( ) )+“”+“\n”+

| | |
|---|---|
| “ | Thank You,”+“\n”+ |
| “ | ”+ getPrintableValue(Publisher.getCustomerServiceName( ) )+“”+“\n”+ |
| “ | “+getPrintableValue(Publisher.getName( ) )+””); |
| | msg.append(“</TextContent>\n”); |
| | msg.append(“<HtmlContent>\n”); |
| | msg.append(“<Subject>\n”); |
| | msg.append(“Notice of Statement Delivery”); |
| | msg.append(“</Subject>\n<![CDATA[ ”); |
| | msg.append(“<html><body>”+“\n”+ |
| “ | <font face=\“Arial\”>“+”\n”+ |
| “ | <p>“+getPrintableValue(TargetUserInfo.getFirstName( ) )+”,<”<p>“+”\n”+ |
| “ | <p>“+”+ |
| “ | You have received a Statement for the most recent billing period.<br>“+”\n”+ |
| “ | Make certain this information is correct and submit payment by”+ |

getPrintableValue(Statement.getDueDate( ) )+“.<br>“+”\n”+

| | |
|---|---|
| “ | If you find any discrepancies, you can contact Customer Service at:</p>“+”\n”+ |
| “ | <table cellpadding=\“0\” cellspacing=\“0\” border=\“0\”>“+”\n”+ |
| “ | <tr>“+”\n”+ |
| “ | <td align=\“left\”>Telephone:&nbsp;</td>“+”\n”+ |
| “ | <td align=\“left\”>”+ |

getPrintableValue(Publisher.getCustomerServicePhoneNumber( ) )+“</td>”+“\n”+

| | |
|---|---|
| “ | </tr>“+”\n”+ |
| “ | </table>“+”\n”+ |
| “ | <p>Thank You,</p>“+”\n”+ |
| “ | <p><b>“”+getPrintableValue(Publisher.getCustomerServiceName( ) |

)+“</b><br>“+”\n”+

| | |
|---|---|
| “ | “+ getPrintableValue(Publisher.getName( ) )+”</p>“+”\n”+ |
| “ | </font>“+”\”+ |
| “ | </body></html>”); |
| | msg.append(“]]> </HtmlContent>\n”); |
| | msg.append(“</D3EmailMessage>\n”); |

}
Message = msg;
CAT.debug(LogUtil.METHOD_END+thisMethodsSignature);

}
/* This method returns subject to the calling program. It calls resolves the variables using the
resolveVariables method. Errors should be handled by the calling program*/
public String getSubject(String type) throws Exception
{

final String thisMethodsSignature = “getSubject(String type)”;
CAT.debug(LogUtil.METHOD_BEGIN+thisMethodsSignature);
resolveVariables( );
if (TargetUserInfo.getGroupName( ).equalsIgnoreCase(“Admin”))
{

text_subject =“Notice of Statement Delivery”;
html_subject =“”;

}
else
{

text_subject =“Notice of Statement Delivery”;
html_subject =“Notice of Statement Delivery”;

}
CAT.debug(LogUtil.METHOD_END+thisMethodsSignature);
if (type.equalsIgnoreCase(“TEXT”))

return text_subject;

else

return html_subject;

}
/* This method Resolves the variables found in the message by accessing the D3 database.

Errors should be handled by the calling method*/

protected void resolveVariables( ) throws Exception
{

final String thisMethodsSignature = “resolveVariables( )”;
CAT.debug(LogUtil.METHOD_BEGIN+thisMethodsSignature);
DataSourceConnection connection = null;
try{
connection = dataFactory.allocateConnection ( );

StatementSet StatementSet =null;
try
{
StatementMapper StatementMapper =

dataFactory.getStatementMapper(connection,

getMultiTenantBoolean( ));

DataFilterObject dataFilterObject = new FilterComparisonExpression (

Statement.STATEMENTID_FN,Operator.EQ,Event.getStatementId( ));

StatementSet =StatementMapper.find(dataFilterObject, null, 1);
Statement = StatementSet.getNextStatement( );
}
catch(Exception e)
{
throw e;
}
finally{ if (StatementSet !=null) StatementSet.close( );
}
PublisherSet PublisherSet =null;
try
{
PublisherMapper PublisherMapper =

dataFactory.getPublisherMapper(connection,

getMultiTenantBoolean( ));

DataFilterObject dataFilterObject = new FilterComparisonExpression (

Publisher.PUBLISHERID_FN,Operator.EQ,Event.getPublisherId( ));

PublisherSet =PublisherMapper.find(dataFilterObject, null, 1);
Publisher = PublisherSet.getNextPublisher( );
}
catch(Exception e)
{
throw e;
}
finally{ if (PublisherSet !=null) PublisherSet.close( );
}

}catch(Exception e) { throw e;}
finally
{
try { if (connection != null) dataFactory.releaseConnection (connection);}
catch (DataException e) { throw e; }
}
CAT.debug(LogUtil.METHOD_END+thisMethodsSignature);

}

Statement Statement =null;
Publisher Publisher= null;
UserInfo TargetUserInfo = null;
String text _subject = “”;
String html_subject = “”;

}

What is claimed is:

1. An electronic bill presentment computer system for providing bill information from a biller to a remote customer over a network, the electronic bill presentment computer system generating event notification messages during operation, the event notification messages being customized to meet preferences of the biller, the electronic bill presentment computer system configured and programmed to include:
an event messaging descriptor repository storing customized information for event notification messaging in accordance with biller preferences;
an event business module processing predetermined events;
an event messaging logic module responsive to an occurrence of a predetermined event in the event business module, the event messaging logic module generating customized event messages based on corresponding customized information stored in the event messaging descriptor repository;
a message delivery means transmitting said customized event messages to one or more recipients; and
wherein the event messaging descriptor repository is discrete from the event messaging logic module, thereby providing that said repository independently reflects the biller's particular preferences, the information in said repository being customizable for the biller.

2. The system of claim 1 wherein the event messaging descriptor repository is stored using descriptors in XML format.

3. The system of claim 1 wherein the event messaging descriptor repository includes a plurality of message templates corresponding to different events handled by the event business module.

4. The system of claim 3 wherein the plurality of message templates includes a first message template in a first language and a second message template in a second language, the first and second message templates corresponding to a same event, and the event messaging logic module selecting one of the first or second message templates based on recipient information.

5. The system of claim 3 wherein at least one of the message templates includes a first body of text for a first recipient and a second body of text for a second recipient, and the message delivery means delivers the first body of text to the first recipient and the second body of text to the second recipient.

6. The system of claim 1 wherein the event messaging descriptor repository includes a listing of a customized set of events for which event messages will be produced upon occurrence of said set of events in the event business module.

7. The system of claim 6 wherein the event messaging descriptor repository further includes a customized set of parameters for controlling the event messaging logic to process messages for each of the customized set of events.

8. The system of claim 7 wherein the event messaging descriptor repository further includes a plurality of message templates corresponding to the customized set of events.

9. The system of claim 8 wherein the plurality of message templates includes a first message template in a first language and a second message template in a second language, the first and second message templates corresponding to a same event, and the event messaging logic module selecting one of the first or second message templates based on recipient information.

10. The system of claim 8 wherein at least one of the message templates includes a first body of text for a first recipient and a second body of text for a second recipient, and the message delivery means delivers the first body of text to the first recipient and the second body of text to the second recipient.

11. The system of claim 8 wherein the event messaging descriptor repository is stored using descriptors in XML format.

12. A method for providing notification messages of electronic bill presentment events over a network, the event notification messages being customized to meet preferences of a biller, the method comprising:
storing customized information for event notification messaging in accordance with biller preferences;
detecting occurrences of predetermined events;
storing event messaging code logic independent of the customized information
responsive detecting a predetermined event, the event messaging code logic generating customized event messages based on the stored corresponding customized information; and
transmitting said customized event messages to one or more recipients.

13. The method of claim 12 wherein the step of storing event messaging code includes providing an update to the event messaging code without affecting the customized information for event notification.

14. The method of claim 12 wherein the step of storing customized information includes storing descriptors in XML format.

15. The method of claim 12 wherein the step of storing customized information includes storing a plurality of message templates corresponding to different of the predetermined events, the step of generating including making the customized event messages from the templates.

16. The method of claim 15 wherein the step of storing the plurality of message templates further includes storing a first message template in a first language and storing a second message template in a second language, the first and second message templates corresponding to a same event, and the step of generating further including selecting one of the first or second message templates based on recipient information.

17. The method of claim 15 wherein the step of storing the plurality of message templates further includes, for at least one of said templates, storing a first body of text for a first recipient and a second body of text for a second recipient, and wherein the step of delivering includes delivering the first body of text to the first recipient and the second body of text to the second recipient.

18. The method of claim 12 wherein the step of storing customized information includes storing a listing of a customized set of events for which event messages will be produced upon detecting of said set of events.

19. The method of claim 18 wherein the step of storing customized information further includes storing a customized set of parameters for controlling the step of generating event messages for each of the customized set of events.

20. The method of claim 19 wherein the step of storing customized information further includes storing a plurality of message templates corresponding to the customized set of events.

21. The method of claim 20 wherein the step of storing the plurality of message templates further includes storing a first message template in a first language and storing a second message template in a second language, the first and second message templates corresponding to a same event, and the step of generating further including selecting one of the first or second message templates based on recipient information.

22. The method of claim 20 wherein the step of storing the plurality of message templates further includes, for at least one of said templates, storing a first body of text for a first recipient and a second body of text for a second recipient, and wherein the step of delivering includes delivering the first body of text to the first recipient and the second body of text to the second recipient.

23. The method of claim 20 wherein the step of storing customized information includes storing descriptors in XML format.
